(19) United States
(12) Patent Application Publication
(10) Pub. No.: US 2015/0354449 A1
(43) Pub. Date: Dec. 10, 2015

(54) Below Wing Reverse Core Gas Turbine Engine With Thrust Reverser

(71) Applicant: UNITED TECHNOLOGIES CORPORATION, Hartford, CT (US)

(72) Inventors: Gabriel L. Suciu, Glastonbury, CT (US); Jesse M. Chandler, South Windsor, CT (US)

(21) Appl. No.: 14/759,703

(22) PCT Filed: May 10, 2013
(86) PCT No.: PCT/US13/40487

§ 371 Date: Jul. 8, 2015

Related U.S. Application Data
(60) Provisional application No. 61/752,078, filed on Jan. 14, 2013.

(51) Int. Cl. F02C 3/107; F02K 1/70

(52) U.S. Cl. CPC F02C 3/107; F02K 1/70

(57) ABSTRACT

A core engine includes a compressor section, a combustor and a turbine section, with the turbine section being closest to a fan, the combustor section and then the compressor section being positioned further away from the fan relative to the turbine section. A downstream end of a nozzle has at least one pivoting shell and an actuator pivots the shell between a stowed position and a deployed position. A mount bracket is mounted at one circumferential location of the engine. The shell moves in a direction having at least a component perpendicular to a vertical direction defined perpendicular to a top surface of the mount bracket.

### BACKGROUND OF THE INVENTION

This application relates to the inclusion of a thrust reverser at a rear end of a gas turbine engine which utilizes a reverse core concept.

Gas turbine engines are known, and typically include a fan delivering air into a compressor section and also outwardly of the compressor as bypass air. Air from the compressor section passes into a combustor, is mixed with fuel, and ignited. Products of this combustion pass downstream over turbine rotors, driving them to rotate.

One recently developed type of gas turbine engine is a so-called “reverse core” gas turbine engine. In typical gas turbine engines, the fan is positioned axially at an end of an engine, and then the compressor, combustor and turbine section are placed in that order. In a reverse core gas turbine engine, the turbine is adjacent the fan, and the combustor is at an inner end of the turbine, with the compressor positioned even more inwardly.

A thrust reverser is utilized once an aircraft carrying the gas turbine engine has landed, and acts to create a reverse force to slow the aircraft.

One concept that has been proposed in gas turbine engines is a thrust reverser provided by pivoting shell halves at the rear of a nozzle. Such thrust reversers were generally utilized in prior gas turbine engines which used little, or no, bypass air.

In addition, various types of thrust reversers have been incorporated into more modern gas turbine engines which do have a large fan providing bypass air as propulsion, and in addition to the air passing through the compressor. However, this standard type of gas turbine engine generally had an engine core that extended beyond the end of the nozzle, such that the shell halves could not pivot inwardly to a reverse thrust position.

### SUMMARY OF THE INVENTION

In a featured embodiment, a gas turbine engine has an outer housing defining a nozzle at a downstream end of the engine. A fan is mounted at an upstream end of the engine. The fan rotates on a first axis, and the nozzle is centered on the first axis. A core engine includes a compressor section, a combustor and a turbine section. The turbine section is closest to the fan. The combustor section and then the compressor section are positioned further away from the fan relative to the turbine section. The nozzle has at least one pivoting shell and an actuator to pivot the at least one shell between a stowed position and a deployed position in which the at least one shell pivots outwardly to provide a thrust reverser. A mount bracket is mounted at one circumferential location of the engine, and defines a vertically upper location. The at least one shell moves in a direction having at least a component perpendicular to a vertical direction defined perpendicular to a top surface of the mount bracket.

In another embodiment according to the previous embodiment, the core engine is positioned on a second axis. The first axis and the second axis are non-parallel.

In another embodiment according to any of the previous embodiments, the second axis extends in a direction toward the top surface of the bracket from the turbine section toward the compressor.

In another embodiment according to any of the previous embodiments, the second axis extends in a direction away from the top surface of the bracket from the turbine section toward the compressor.

In another embodiment according to any of the previous embodiments, there is a pair of the pivoting shells.

In another embodiment according to any of the previous embodiments, each of the shells are driven by a linkage to move between the in-flight flight position and the deployed position.

In another embodiment according to any of the previous embodiments, the fan delivers air into the compressor section, and also delivers bypass air to the nozzle.

In another embodiment according to any of the previous embodiments, the core engine is positioned on a second axis. The first axis and the second axis are non-parallel.

In another embodiment according to any of the previous embodiments, the at least one shell is driven by a linkage to move between the in-flight position and the deployed position, and the linkage being mounted within fixed portions of the nozzle.

In another embodiment according to any of the previous embodiments, the at least one shell movement direction is perpendicular to the vertical direction.

In another embodiment according to any of the previous embodiments, a fan drive turbine is positioned downstream of the turbine section of the core engine.

In another embodiment according to any of the previous embodiments, a gear reduction is included between the fan drive turbine and the fan. The fan rotates at a slower speed than the fan drive turbine.

In another embodiment according to any of the previous embodiments, the core engine turbine section and the fan drive turbine are separate turbines.

In another embodiment according to any of the previous embodiments, the fan drive turbine rotates on the first axis and the core engine is positioned on a second axis. The first axis and the second axis are non-parallel.

In another featured embodiment, an aircraft has a gas turbine engine mounted beneath a wing. The gas turbine engine includes an outer housing defining a nozzle at a downstream end of the engine. A fan is mounted at an upstream end of the engine. The fan rotates on a first axis. The nozzle is centered on the first axis. A core engine includes a compressor section, a combustor and a turbine section, with the turbine section being closest to the fan. The combustor section and then the compressor section are positioned further away from the fan relative to the turbine section. The nozzle has at least one pivoting shell and an actuator to pivot the at least one shell between a stowed position and a deployed position in which the at least one shell pivots outwardly to provide a thrust reverser. A mount bracket is mounted at one circumferential location of the engine and fixed to an underside of the wing, and defines a vertically upper location. The at least one shell moves in a direction having at least a component perpendicular to a vertical direction defined from the first axis and perpendicular to a top surface of the mount bracket.

In another embodiment according to the previous embodiment, the core engine is positioned on a second axis and the first axis and the second axis are non-parallel.

In another embodiment according to any of the previous embodiments, the at least one shell movement direction is perpendicular to the vertical direction.

In another embodiment according to any of the previous embodiments, a fan drive turbine is positioned downstream of the turbine section of the core engine.

In another embodiment according to any of the previous embodiments, a gear reduction is included between the fan drive turbine and the fan. The fan rotates at a slower speed than the fan drive turbine.

In another embodiment according to any of the previous embodiments, there is a pair of the pivoting shells.

These and other features of this application will be best understood from the following specification and drawings, the following of which is a brief description.

### BRIEF DESCRIPTION OF THE DRAWINGS

FIG. 1 shows a gas turbine engine mounted to an aircraft wing.

FIG. 2A shows a nozzle in a normal thrust position.

FIG. 2B shows the nozzle in a reversed thrust position.

FIG. 3A is a top view of the FIG. 2A position.

FIG. 3B is a top view of the FIG. 2B position.

FIG. 4 shows internal details of the engine.

FIG. 5 shows further internal details.

FIG. 6 shows an alternative embodiment.

FIG. 7 shows another alternative embodiment.

### DETAILED DESCRIPTION

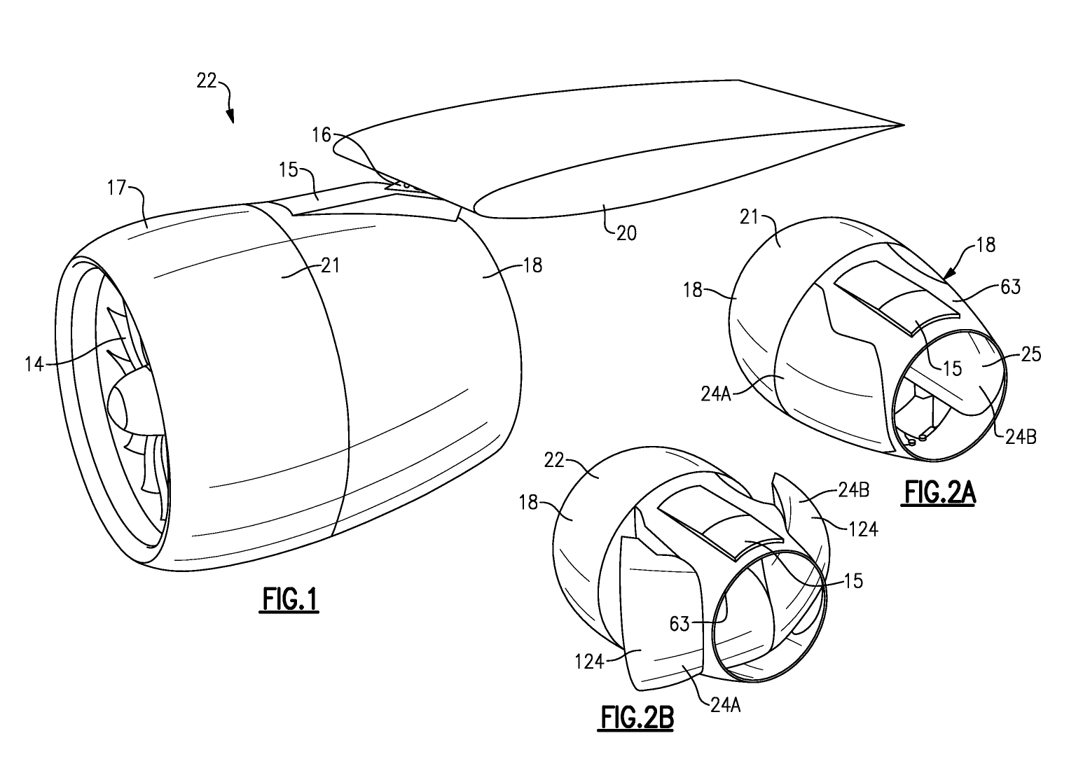

FIG. 1 shows an aircraft wing 20 having engine mount structure 16 mounted to a mount bracket 15 on a gas turbine engine 22. The gas turbine engine 22 has a nacelle 21 having a fixed structure 17 and a fan 14. A nozzle 18 is defined at a rearward position, and has a fixed portion including the mount bracket 15.

A thrust reverser is incorporated into the nozzle 18, as will be explained below.

In co-pending application Ser. No. 13/590,223 titled REVERSE FLOW GAS TURBINE ENGINE WITH THRUST REVERSER filed on Aug. 21, 2012, the disclosure of which is incorporated herein by reference, a thrust reverser structure is disclosed incorporated into a nozzle. This thrust reverser is for an engine sitting atop an aircraft body.

The thrust reverser has opposing clamshell halves that pivot in a vertical direction. Such an embodiment would not readily incorporated beneath the wing 20.

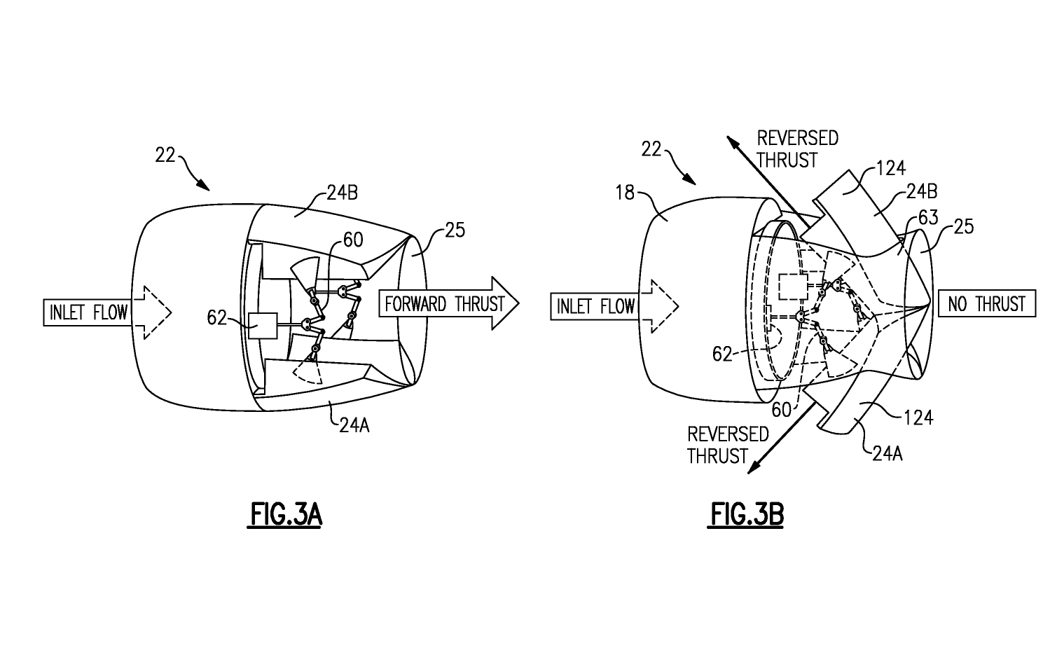

As shown in FIG. 2A, the engine 22 has the nozzle 18 incorporating a fixed portion 63 and pivoting opposing first and second clamshell halves 24A and 24B, used as thrust reversers. As shown in FIG. 2A, the pivoting clamshell halves 24A and 24B that are in a closed position. In this position, the fan 14 delivers bypass air as thrust through an exit nozzle 25.

As shown in FIG. 2B, the clamshell halves 24A and 24B have been moved to a pivoted position 124 at which they block a flow area of the exit nozzle 25. In this position, continued thrust from the fan 14 will create a force resisting forward movement of an aircraft associated with the wing 20.

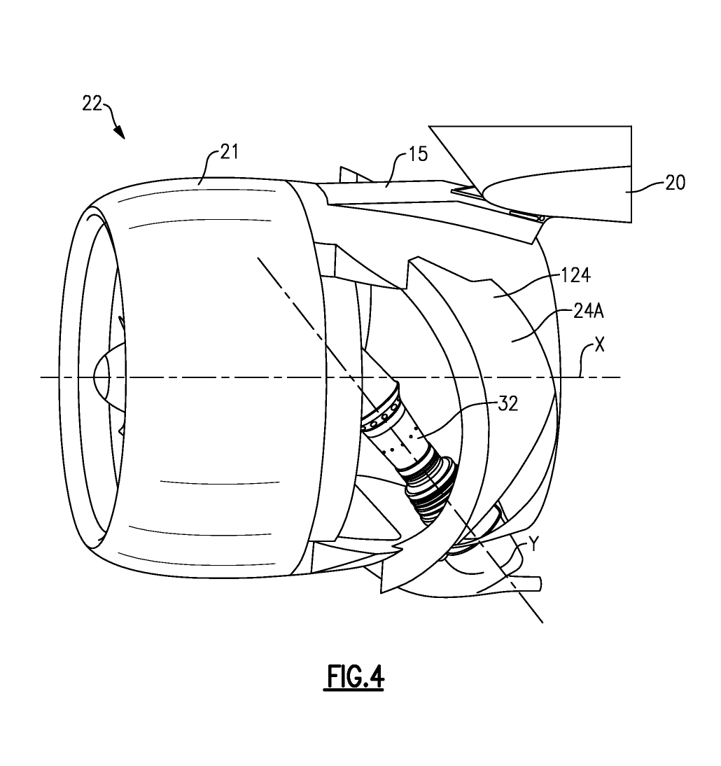

FIG. 3A corresponds to FIG. 2A and shows the engine 22 having a linkage 60 driven by an actuator 62. The actuator 62 is fixed within a fixed housing portion 63. The position shown in FIG. 3A is a normal flight position.

Once an aircraft associated with the engine 22 has landed, the actuator 62 drives the linkage 60 into a deployed position in which the clamshell halves 24A and 24B block the area of exit nozzle 25. The fan and turbine section continue to deliver exhaust air against the deployed shell halves 24A and 24B in position 124, and create reverse thrust tending to slow the aircraft.

Although the mount bracket 15 is not illustrated in these drawings, it should be understood that it would sit on top of the plane of the fixed portion 63. Thus, the pivoting movement of the clamshell halves 24A and 24B to the deployed position 124 is perpendicular to a top surface of the mount bracket 15, and will generally be in a horizontal position when the engine 22 is mounted to a wing 20. There is thus room for this movement under the wing.

FIG. 4 shows the engine 22 with the clamshell halves 24A and 24B in the deployed position 124. A core engine 32 is illustrated within the engine. The core engine 32 is a reverse core engine. The core engine 32 is better shown in FIG. 5, and has the fan 14 operating along an axis x, whereas the core operates on an axis y, which is non-parallel (for example, perpendicular) to the axis x.

The reverse core engine 32 has an inlet duct 40 which captures a portion of the fan stream bypass air, and a particle separator 41 for delivering impurities from the air to the outside environment.

Turning vanes 39 turn the air to a compressor section 46. The duct 40 is over a limited circumferential extent. At other circumferential locations, air flows as bypass air for propulsion. The air is compressed and delivered into a combustion section 48, where it mixes with fuel and is ignited. Products of this combustion pass over turbine section 50, which drives the compressor section 34. The products of the combustion then pass over a fan drive turbine section 44, driving the fan 14 to rotate. The fan drive turbine 44 rotates on axis X. A gear reduction 43 allows the fan 14 to rotate more slowly than does the fan drive turbine 44. The illustrated jet engine 32 is a “reverse core engine” in that the compressor 46 is positioned further into the engine then is the turbine 50.

Since the core engine 32 is on the non-parallel axis y, a relatively long core engine 32 can be achieved without the core engine 32 blocking the exit nozzle 25. Thus, with this engine arrangement, a thrust reverser utilizing the clamshell halves 24A and 24B can be incorporated. Further, since the clamshell halves 24A and 24B pivot in a direction that has at least a component in what will be in the horizontal direction, or perpendicular to a top surface of mount bracket 15, the clamshell halves 24A and 24B can pivot to the deployed position 124 without interfering with the wing 20.

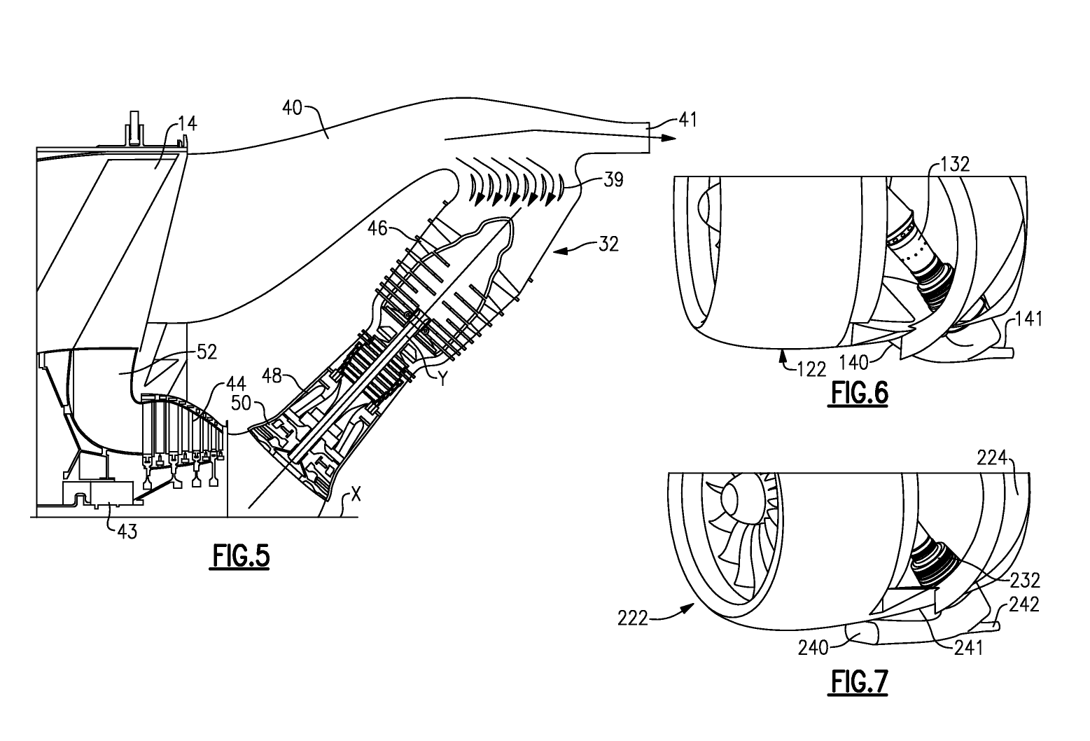

FIG. 6 shows an alternative core engine 132, wherein the engine 132 extends along an axis which is generally vertically downwardly, and opposed to the direction of the axis y in FIG. 5. An inlet duct 140 operates as in the FIG. 5 embodiment, as does a particle separator 141.

FIG. 7 shows yet another alternative engine 222, wherein the core inlet 232 receives air from an inlet duct 240 which is outward of the fixed portion 241 of a nozzle including pivoting shell halves 224, again, a particle separator 242 is disclosed

Although an embodiment of this invention has been disclosed, a worker of ordinary skill in this art would recognize that certain modifications would come within the scope of this invention. For that reason, the following claims should be studied to determine the true scope and content of this invention.

1. A gas turbine engine comprising:
an outer housing defining a nozzle at a downstream end of the engine;
a fan mounted at an upstream end of the engine, the fan rotating on a first axis, and the nozzle centered on the first axis;
a core engine, including a compressor section, a combustor and a turbine section, with the turbine section being closest to the fan, the combustor section and then the compressor section being positioned further away from the fan relative to the turbine section; the nozzle having at least one pivoting shell and an actuator to pivot the at least one shell between a stowed position and a deployed position in which the at least one shell pivots outwardly to provide a thrust reverser; and
a mount bracket mounted at one circumferential location of the engine, and defining a vertically upper location, and the at least one shell moving in a direction having at least a component perpendicular to a vertical direction defined perpendicular to a top surface of the mount bracket.

2. The gas turbine engine as set forth in claim 1, wherein the core engine is positioned on a second axis and the first axis and the second axis are non-parallel.

3. The gas turbine engine as set forth in claim 2, wherein the second axis extends in a direction toward the top surface of the bracket from the turbine section toward the compressor.

4. The gas turbine engine as set forth in claim 2, wherein the second axis extends in a direction away from the top surface of the bracket from the turbine section toward the compressor.

5. The gas turbine engine as set forth in claim 1, wherein there is a pair of the pivoting shells.

6. The gas turbine engine as set forth in claim 5, wherein each of the shells are driven by a linkage to move between the in-flight flight position, and the deployed position.

7. The gas turbine engine as set forth in claim 1, wherein the fan delivers air into the compressor section, and also delivers bypass air to the nozzle.

8. The gas turbine engine as set forth in claim 7, wherein the core engine is positioned on a second axis and the first axis and the second axis are non-parallel.

9. The gas turbine engine as set forth in claim 1, wherein the at least one shell is driven by a linkage to move between the in-flight position and the deployed position, and the linkage being mounted within fixed portions of the nozzle.

10. The gas turbine engine as set forth in claim 1, wherein the at least one shell movement direction being perpendicular to the vertical direction.

11. The gas turbine engine as set forth in claim 1, further comprising:
a fan drive turbine positioned downstream of the turbine section of the core engine.

12. The gas turbine engine as set forth in claim 11 including a gear reduction between the fan drive turbine and the fan, and wherein the fan rotates at a slower speed than the fan drive turbine.

13. The gas turbine engine as set forth in claim 12, wherein the core engine turbine section and the fan drive turbine are separate turbines.

14. The gas turbine engine as set forth in claim 12, wherein the fan drive turbine rotates on the first axis and the core engine is positioned on a second axis and the first axis and the second axis are non-parallel.

15. An aircraft comprising:
a gas turbine engine mounted beneath a wing;
the gas turbine engine including an outer housing defining a nozzle at a downstream end of the engine, a fan mounted at an upstream end of the engine, the fan rotating on a first axis, and the nozzle centered on the first axis, a core engine, including a compressor section, a combustor and a turbine section, with the turbine section being closest to the fan, the combustor section and then the compressor section being positioned further away from the fan relative to the turbine section, the nozzle having at least one pivoting shell and an actuator to pivot the at least one shell between a stowed position and a deployed position in which the at least one shell pivots outwardly to provide a thrust reverser; and
a mount bracket mounted at one circumferential location of the engine and fixed to an underside of the wing, and defining a vertically upper location, and the at least one shell moving in a direction having at least a component perpendicular to a vertical direction defined from the first axis and perpendicular to a top surface of the mount bracket.

16. The aircraft as set forth in claim 15, wherein the core engine is positioned on a second axis and the first axis and the second axis are non-parallel.

17. The aircraft as set forth in claim 15, wherein the at least one shell movement direction being perpendicular to the vertical direction.

18. The aircraft as set forth in claim 15, further comprising:
a fan drive turbine positioned downstream of the turbine section of the core engine.

19. The aircraft as set forth in claim 18, including a gear reduction between the fan drive turbine and the fan, and wherein the fan rotates at a slower speed than the fan drive turbine.

20. The aircraft as set forth in claim 15, wherein there is a pair of the pivoting shells.
